(19) United States
(12) Patent Application Publication
(10) Pub. No.: US 2008/0250074 A1
(43) Pub. Date: Oct. 9, 2008

(54) Recoverable last resource commit

(75) Inventor: Paul Parkinson, Wenonah, NJ (US)

Correspondence Address: HICKMAN PALERMO TRUONG & BECKER/ORACLE, 2055 GATEWAY PLACE, SUITE 550, SAN JOSE, CA, 95110-1083, US

(73) Assignee: ORACLE INTERNATIONAL CORPORATION, REDWOOD SHORES, CA (US)

(21) Appl. No.: 11/732,951

(22) Filed: Apr. 4, 2007

(51) Int. Cl. G06F 17/00

(52) U.S. Cl. 707/200

(57) ABSTRACT

A method and apparatus for reducing logging overhead in systems where at least some of the participants conform to the two-phase commit protocol is provided. Transaction logging is eliminated at the transaction manager. The fault recovery mechanism is altered to obtain transaction status from participating resource managers logs, instead of relying on transaction manager logs.

### FIELD OF THE INVENTION

The present invention relates to the field of distributed database transaction processing.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Reliable distributed transaction processing involves coordinating a set of two or more local transactions that span multiple databases while guaranteeing the ACID properties of atomicity, consistency, isolation, and durability. A common approach to ensure atomic processing of a distributed transaction is for all parties to a transaction to agree to use a two-phase commit protocol. The two-phase commit protocol is a distributed algorithm that specifies how a global transaction manager and resource managers reach a consensus on whether to commit or abort transactions in view of various error conditions. The two-phase commit protocol relies on write-ahead logging at every participant and coordination by the transaction manager to achieve atomicity in spite of possible errors. Write-ahead logging is a technique for storing all modifications in a log and associated data structures before the modifications are applied to the database. Coordination by the transaction manager is conducted through a standard interface. Resources that conform to that interface are said to be XA-compliant as described in the X/Open XA specification.

An example of a distributed transaction is given in the context of an electronic transfer of money between two banks, B1 and B2. The money must be withdrawn from one bank account and deposited into another. Either both operations must occur or none of the operations must occur. Any other scenario is erroneous. For example, if money is withdrawn from B1, but not deposited in B2, or money is deposited in B2 but not withdrawn from B1, then the result is erroneous. Typically, B1 and B2 keep account records in separate databases. Each database is managed by its own resource manager. A modification by a bank application to any attribute of a bank account causes the database resource manager to modify the corresponding database record. Two-phase commit protocol could be used to conduct the transaction.

The two-phase commit protocol splits transaction processing into two distinct phases: prepare and commit. The two phases are coordinated by a transaction manager. The prepare phase can be divided into four distinct steps: the transaction manager sending prepare messages to all the participating resource managers, each participating resource manager preparing for the transaction, each participating resource manager sending a prepare acknowledge message to the transaction manager, and the transaction manager waiting for the prepare acknowledge messages from all the resource managers. The transaction manager records the identity of every resource manager involved in the transaction, assigns a unique id to the transaction and writes the id and a log before sending prepare messages to resource managers. When a resource manager prepares for a transaction, the resource manager locks the resources needed for that particular transaction. Locked resources are only accessible to the resource manager for the duration of that particular transaction. Other entities are unable to manipulate the locked resources. Resource reservation ensures database consistency. The resource manager executes its part of the transaction and writes the results to a log file without making the changes permanent. At that point, the resource manager sends a prepared acknowledge message. The transaction manager waits for prepare acknowledge messages from every participating resource manager, and verifies with the transaction manager log.

Once the transaction manager receives acknowledge messages from every participating resource manager, the commit phase begins. The commit phase can take two execution paths depending whether any errors occurred in the prepare phase. In case the prepare phase completes without any errors, the commit phase consists of the following steps: transaction manager sends commit messages to each participating resource manager, each participating resource manager commits the transaction and releases the reserved resources, each resource manager then sends a commit successful message, and finally, once the resource manager has received commit successful messages from every resource manager, the transaction manager completes the transaction. Before sending the “commit” message, the transaction manager logs the transaction id as well as the identification of all the resource managers to which the “commit” message was sent. After a resource manager receives a commit message, the resource manager commits the transaction by transferring the changes in the resource manager's log to stable storage.

The commit phase may take another execution path in the event of an error. Errors can occur for a multitude of reasons, such as a program error, computer crash, or network outage. An error detected at a resource manager during the prepare phase may cause the resource manager to send a negative acknowledgement. The transaction manager will roll back the transaction if it receives negative acknowledgements during the prepare phase. In case of a transaction rollback, the following sequence of steps are performed in the two-phase commit protocol: transaction manager sends a rollback message to the participating resource managers, each resource manager rolls back the transaction and releases resources, each resource manager sends an acknowledgement to the transaction manager, and finally, the transaction manager completes the transaction.

While conformance to the two-phase commit protocol by all participants provides synchronization of commit and rollback actions in a distributed transaction, there are systems that require integration of participants that do not conform to the two-phase commit protocol. One approach to integrate a non-XA-compliant resource is to simply skip the prepare phase for the XA-non-compliant resource at the expense of introducing a window of error vulnerability.

The two-phase commit protocol is modified as follows. The transaction manager prepares XA-compliant resources as described earlier. After receiving the appropriate acknowledgement messages, the transaction manager then attempts to commit the XA-non-compliant resource. In absence of any error conditions, the XA-non-compliant resource will return the commit status. Based on the return value of XA-non-compliant and XA-compliant participants, the transaction manager can proceed with the commit phase.

The window of error vulnerability occurs during the response of the XA-non-compliant resource. For example, in the event of a network outage, the transaction manager may receive an ambiguous indication of the commit status of the XA-non-compliant resource. In that case, the transaction manager is unable to determine an appropriate action: to roll back or to commit XA-compliant resources. An ambiguous response by an XA-compliant resource is not an issue, because every XA-compliant resource is required to hold locks, log its transactions, and provide, to the transaction manager, an interface to query the logs. An incorrect decision by the transaction manager will result in an inconsistent system state. For example, if the non-XA-compliant resource committed, and the transaction manager tells XA-compliant resource manager to roll back, or the other way around, the transaction becomes inconsistent. That would be analogous to the situation of money being withdrawn from B1 and not deposited into B2. Moreover, it is impossible to query the status of non-XA-compliant resources.

An alternate approach to integrate a XA-non-compliant resource without introducing an error vulnerability window exploits the atomicity offered by any local database transaction. Atomicity is exploited to approximate the two phases of the two-phase commit protocol in a participating non-XA-compliant resource. The two phases are approximated by installing a custom table in a non-XA-compliant resource, augmenting the responsibilities of the transaction manager and appropriately modifying the two-phase commit protocol.

The custom table is installed as a part of the database that is managed by the non-XA-compliant resource manager. The transaction manager must know the schema of the custom table. The transaction manager is unaware of the schema of other tables involved in the distributed transaction. The modified two-phase commit protocol performs the following actions during the prepare phase. The transaction manager establishes a database connection with a non-XA-compliant resource manager and uses the connection to instruct the resource manager to insert a row in the custom table as a part of the non-XA-compliant resource manager's local transaction. The inserted row contains a transaction ID. Because of local atomicity, the inserted row only becomes a permanent part of the custom table after the transaction commits. Therefore, the presence of the row ID in the custom table serves as an indicator of transaction status.

In case the transaction manager receives an ambiguous response from the non-XA-compliant resource, the transaction manager can query the custom table for the transaction id in question. Existence of the transaction id in the custom table indicates to the transaction manager that the local transaction committed. Then the transaction manager can send the commit instruction to XA-compliant resources. Alternatively, if the transaction manager queried the table and did not see the transaction ID, then the transaction manager can tell all the XA resources it is controlling to roll back the transaction. When such a transaction is complete a record of the transaction ID is put on a queue maintained by the transaction manager and the corresponding rows in the table are purged in batches.

It is evident that with a strictly two-phase approach to distributed transaction processing, as well as hybrid approaches, there is a heavy reliance on logging. Every participant in the transaction must force write out to its respective log before performing any operation. Writing to a log in stable storage is a computationally costly operation. Moreover, log writes must occur at every transaction participant. There is clearly a need to optimize logging in the two-phase commit protocol.

### DESCRIPTION OF THE DRAWINGS

The present invention is illustrated by way of example, and not by way of limitation, in the figures of the accompanying drawings and in which like reference numerals refer to similar elements and in which:

FIG. 1 is a system architecture according to an embodiment of the present invention;

FIG. 2 is a message sequence diagram for communication between transaction and resource managers where all resource managers are XA-compliant, according to an embodiment of the present invention;

FIG. 3 is a message sequence diagram for communication between transaction and resource managers where one resource manager is XA-non-compliant, according to an embodiment of the present invention;

FIG. 4 is flow diagram of a recovery process according to an embodiment of the present invention; and

FIG. 5 is an example computer system, according to an embodiment of the present invention

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques are provided for reducing logging overhead in transactions in which some of the participants do not adhere to the two-phase commit protocol while still retaining atomicity, consistency, isolation, and durability (ACID) database properties. Previously, a transaction manager logged prepare and commit instructions for every distributed transaction. The transaction manager logs were used during recovery to determine whether to commit or roll back the transaction.

In the current approach, logging at the transaction manager is eliminated by installing a custom table at the participating resource that does not conform to the two-phase commit protocol (i.e., non-XA resource). The custom table is modified as part of the work performed by the non-XA resource manager, to contain status of the transaction after the transaction commits. During fault recovery, contents of the custom table serve as an indication of transaction status to the transaction manager.

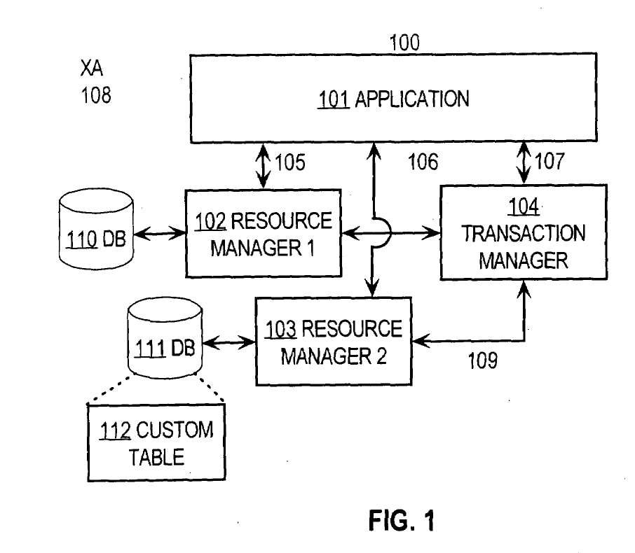

An example of software architecture according to an embodiment of the present invention is given in FIG. 1. The distributed system 100 is driven by an application 101 that conducts transactions spanning multiple databases resources. Each database 110 and 111, involved in the transaction is managed by its respective resource manager 102 and 103 respectively. Resource manager 102 conforms to a two-phase commit protocol while resource manager 103 does not. Application 101 enlists a transaction manager 104 that directs execution of the transaction. Application 101 communicates with transaction manager 104 and resource managers 102 and 103 through their respective APIs 107,105, and 106. Transaction manager 104 communicates with resource manager 102 through an API 108 conforming to the XA standard. Resource manager 103, which does not conform to the two-phase commit protocol, is controlled by transaction manager 104 through an API 109 that is unique. Database 111 contains a custom table 112. Transaction manager 104 is aware of schema of custom table 112 and is able to modify custom table 112 through resource manager 103.

### Transaction Logging

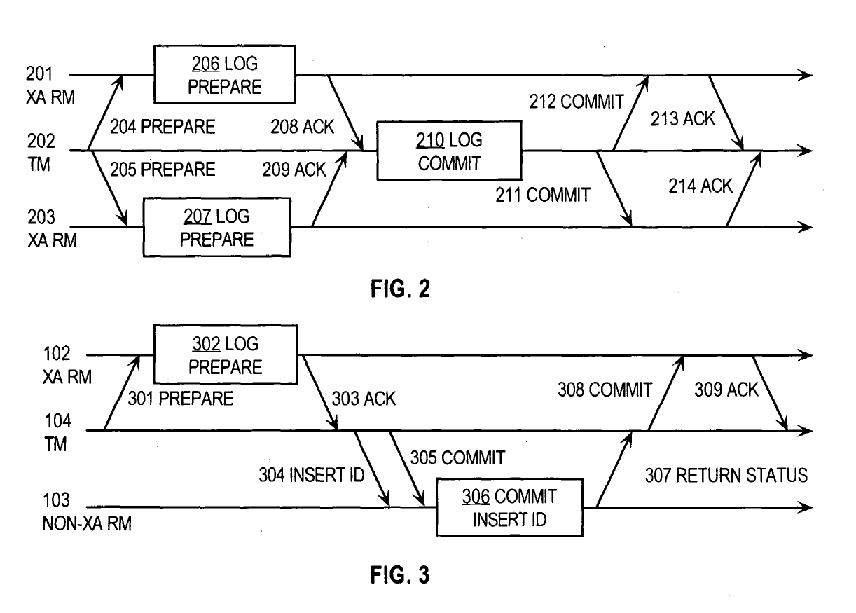

Logging strategy in a distributed transaction depends on whether there are XA-non-compliant resources present in the transaction or not. FIG. 2 depicts a sequence of events in a distributed system where all the participants conform to the two-phase commit protocol, according to an embodiment of the invention. There are three parties to the transaction: resource manager 201, transaction manager 202, and resource manager 203. Each party is associated with a time axis, represented by a horizontal arrow. Time progresses from left to right. The transaction begins when transaction manager 202 sends prepare messages containing transaction IDs 204, and 205 to resource managers 201 and 203 respectively. Transaction manger 202 omits writing a prepare instruction in its log. Because writing to stable storage is a costly operation, eliminating the write creates a performance improvement at transaction manager 202. In response to prepare messages 204 and 205, each resource manager 201 and 203 locks resources that are needed for the transaction, writes a “prepare and transaction id” in its log 206 and 207, writes the necessary undo information, and then executes the transaction to the commit point. Resource managers 201 and 203 then send acknowledgement messages 208 and 209 to the transaction manager 202. The transaction manager 202 waits until it receives every acknowledgement message (208, 209) at which point it begins the commit phase. If any of acknowledgements 208 or 209 are negative, then the transaction manager rolls back the transaction. Alternatively, if acknowledgements 208 and 209 are positive, then transaction manager 202 logs its intention to commit transaction 210. Then transaction manager 202 sends commit instructions 211 and 212 to respective resource managers 203 and 201. Resource managers 201 and 203 finish their unit of work, release the locked resources, and send acknowledgements 213 and 214 to transaction manager 202. Transaction manager 202 waits for acknowledgement messages 213 and 214, and upon reception it considers the transaction complete.

In a distributed transaction where some of the participants do not conform to the two-phase commit protocol, logging strategy can be altered to gain further performance improvement at the transaction manager. FIG. 3 depicts a sequence of events in a distributed transaction in which one resource manager is XA-non-compliant. Parallel to FIG. 2, each of the components XA-compliant resource manager 102, XA-non-compliant resource manager 103, and transaction manager 104 are associated with time axes depicted by three horizontal arrows. Distributed transaction progresses from the left side to the right. Events will be described in chronological order. Transaction manager (TM) 104 begins the distributed transaction by sending a prepare message 301, which contains the transaction ID, to the XA-compliant resource manager (XA RM) 102. In response to the prepare message 301, resource manager 102 records undo information and transaction ID in an appropriate log 302 and then processes its assigned unit of work up to the point of committing it to stable storage. XA-compliant resource manager 102 sends an acknowledgement message 303 to transaction manager 104. Transaction manager 104 then establishes a connection with XA-non-compliant resource manager (RM) 103 and sends, over that connection to resource manager (RM) 103, an instruction to insert 304 a row containing transaction ID in the custom table 112. Resource manager 103, in response to the insert 304 transaction ID instruction, makes inserting a row that contains transaction ID in the custom table 112 a part of it's local transaction work unit. Once transaction manager 104 has received acknowledgements from every involved resource manager, transaction manager 104 instructs resource manager 103 to commit 305 the transaction. Resource manager 103 commits 306 the transaction, which makes both the transaction's work and a row entry in the custom table 112 containing the transaction id permanent. Resource manager 103 then reports commit status 307 to transaction manager 104. Having received a successful commit status 307, transaction manager 104 then sends a commit message 308 to XA-compliant resource manager 102. Transaction manager 104 does not write the “commit transaction id” in its log before sending commit instruction 308. Resource manager 102 then commits its prepared transaction and, upon success, sends an acknowledgement 309 to transaction manager 104. Transaction manager 104 waits for acknowledgements from all XA-compliant resource managers involved in the transaction and then the transaction manager 104 finishes the transaction and releases its reserved resources.

In the case of a distributed transaction involving one XA-non-compliant resource, logging is omitted at the transaction manager, which creates a significant performance improvement. However, fault recovery mechanisms might need to be modified in order to accommodate the new logging strategy and still retain the properties of the two-phase commit protocol.

### Recovery Processing

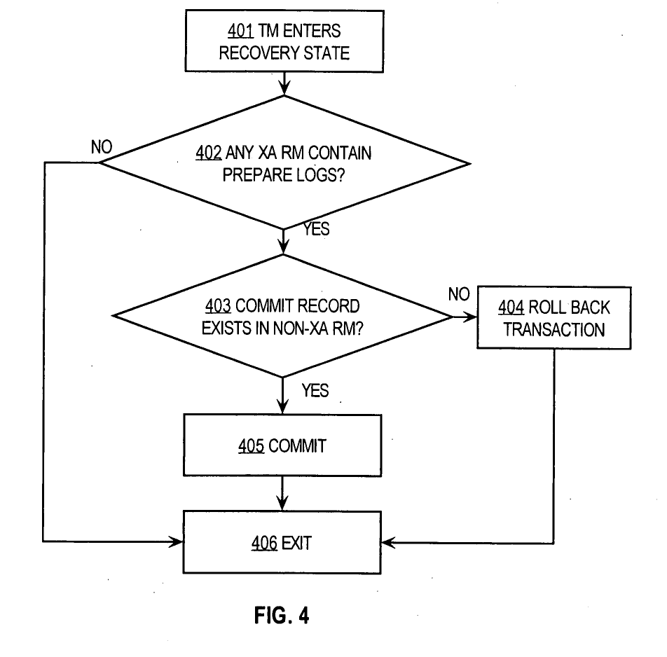

The subcomponent of transaction manager 104 that handles recovery is called the recovery manager. FIG. 4 illustrates steps taken by the recovery manager when an error condition is detected by transaction manager 104. Upon error detection the transaction manager 104 enters 401 recovery state. Because the prepare step is not logged by transaction manager 104 during the prepare phase, the recovery manager queries every XA-compliant resource manager to 402 determine whether the resource manager contains prepare logs. If there are no prepare logs present, then transaction manager 104 knows there are no pending transactions and it exits 406. Alternatively, if any of the XA-compliant resource managers contain transactions in the prepared phase, then transaction manger 104 determines 403 whether a commit record for that transaction exists.

If every resource manager participating in the distributed transaction is XA-compliant, then transaction manager 104 determines the existence of the commit record by looking in its own log. However if there are any resource managers participating in a distributed transaction that are XA-non-compliant, then transaction manager 104 will not have the commit logs. Transaction manager 104 then queries the custom table 112 of the XA-non-compliant resource for a row containing the transaction ID of the previously determined prepared transaction. If the commit log is not present, then the transaction is rolled back 404. On the other hand, if the commit record exists, then transaction manager 104 commits 405 the prepared transactions. As a final step, transaction manager 104 finishes the transaction recovery and exits 406.

### Hardware Overview

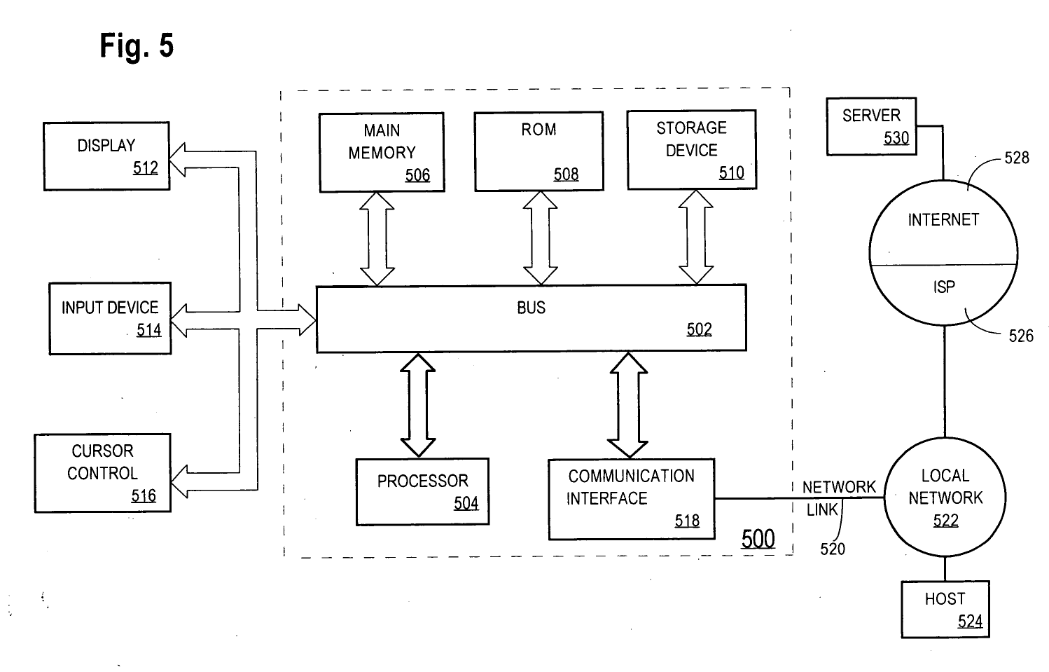

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A system for logging transactions by applications that coordinate multiple resources in a single transaction, the system comprising:
a transaction manager; and
a set of resource managers;
wherein at least one resource manager of said set of resource managers does not conform to a two-phase commit protocol;
wherein said resource manager is associated with a custom table; and
wherein under situations where the transaction manager instructs the resource manager to write a log in the custom table, the transaction manager omits logging prepare or commit instructions to prepare or commit the transaction.

2. The system of claim 1, wherein the log in the custom table contains a transaction id

3. A system for recovering a failed transaction by applications that coordinate multiple resources in a single transaction, the system comprising:
a transaction manager; and
a set of resource managers;
wherein at least one resource manager of said set of resource managers does not conform to a two-phase commit protocol;
wherein the resource manager is associated with a custom table;
wherein the custom table contains a record that indicates a transaction status; and
wherein when the transaction manager is in a failure recovery state, the transaction manager performs, regardless of contents of any log written by the transaction manager indicate, steps comprising:
obtaining a first data set from logs produced by resource managers that conform to the two-phase commit protocol;
obtaining a second data set from the custom table; and
determining, based on the first and second data set, an appropriate action to take relative to the transaction.

4. The system of claim 3, wherein the first data set includes one or more transaction ids of transactions that are currently in progress.

5. The system of claim 3, wherein the first data set is empty.

6. The system of claim 3, where the appropriate action involves the transaction manager instructing the participating resource managers to roll back prepared transactions.

7. The system of claim 3, where the appropriate action involves the transaction manger committing the prepared transaction.

8. A method for logging transactions by a transaction manager that coordinates multiple resources in a single transaction, the method comprising steps of:
issuing a prepare instruction to at least one resource manager that conforms to a two-phase commit protocol;
issuing a database operation to a particular resource that does not conform to the two-phase commit protocol;
wherein a component of said database operation is writing a log in the custom table associated with said resource; and
omitting logging a commit instruction.

9. A method for determining a recovery action by a transaction manager that coordinates multiple resources in a single transaction, the method comprising steps of:
transitioning to a failure recovery state;
obtaining a first data set from logs produced by resource managers that conform to the two-phase commit protocol;
regardless of contents of any log written by the transaction manager, obtaining a second data set from a custom table associated with a resource manager that does not conform to the two-phase commit protocol; and
determining, based on the first and second data set, an appropriate action to take relative to the transaction.

10. The method of claim 9, wherein the first data set includes one or more transaction ids of transactions that are currently in progress.

11. The method of claim 9, wherein the first data set is empty.

12. The method of claim 9, where the appropriate action involves the transaction manager instructing the participating resource managers to roll back the prepared transactions.

13. The method of claim 9, where the appropriate action involves the transaction manger committing the prepared transaction.

14. A computer-readable medium carrying one or more sequences of instructions which, when executed by one or more processors, causes the one or more processors to perform the method recited in claim 1.

15. A computer-readable medium carrying one or more sequences of instructions which, when executed by one or more processors, causes the one or more processors to perform the method recited in claim 2.

16. A computer-readable medium carrying one or more sequences of instructions which, when executed by one or more processors, causes the one or more processors to perform the method recited in claim 3.

17. A computer-readable medium carrying one or more sequences of instructions which, when executed by one or more processors, causes the one or more processors to perform the method recited in claim 4.

18. A computer-readable medium carrying one or more sequences of instructions which, when executed by one or more processors, causes the one or more processors to perform the method recited in claim 5.

19. A computer-readable medium carrying one or more sequences of instructions which, when executed by one or more processors, causes the one or more processors to perform the method recited in claim 6.

20. A computer-readable medium carrying one or more sequences of instructions which, when executed by one or more processors, causes the one or more processors to perform the method recited in claim 7.
